(19) United States
(12) Patent Application Publication
(10) Pub. No.: US 2006/0103670 A1
(43) Pub. Date: May 18, 2006

(54) Image processing method and computer readable medium for image processing

(75) Inventor: Kazuhiko Matsumoto, Minato-ku (JP)

Correspondence Address: PEARNE & GORDON LLP, 1801 EAST 9TH STREET, SUITE 1200, CLEVELAND, OH, 44114-3108, US

(73) Assignee: Ziosoft, Inc., Tokyo (JP)

(21) Appl. No.: 11/175,889

(22) Filed: Jul. 6, 2005

(30) Foreign Application Priority Data
Nov. 15, 2004 (JP) 2004-330638

(51) Int. Cl. G09G 5/00

(52) U.S. Cl. 345/626

(57) ABSTRACT

A multi-value mask as shown in FIG. 2B2 is applied on a target image shown in FIG. 2B1. The multi-value mask can have a real value corresponding to each voxel; for example, the multi-value mask has real values in the boundary area of the target image like “1, 1, 1, 1, 1, 1, 0.8, 0.6, 0.4, 0.2, 0, 0.” Thus, although jaggies caused by a binary mask are conspicuous in the boundary area of a synthesized image in a related art as shown in FIG. 2A3, synthesized voxel values of the synthesized image become “2, 3, 3, 2, 1, 2, 2.4, 2.4, 1.6, 1, 0, 0” as shown in FIG. 2B3, and jaggies in the boundary area of the target image can be made inconspicuous.

This application claims foreign priority based on Japanese Patent application No. 2004-330638, filed Nov. 15, 2004, the contents of which is incorporated herein by reference in its entirety.

### BACKGROUND OF THE INVENTION

1. Field of the Invention

This invention relates to an image processing method for visualizing biological information by performing volume rendering, and a computer readable medium having a program for visualizing biological information by performing volume rendering.

2. Description of the Related Art

A revolution is brought about in the medical field with the advent of CT (computed tomography) and MRI (magnetic resonance imaging) making it possible to directly observe the internal structure of a human body as the image processing technology using a computer improves. Medical diagnosis using the tomographic image of a living body is widely conducted. Further, in recent years, as a technology for visualizing the complicated three-dimensional structure of the inside of a human body which is hardly understood simply from the tomographic image of the human body, for example, volume rendering for directly obtaining an image of the three-dimensional structure without contour extraction process from three-dimensional digital data of an object provided by CT has been used for medical diagnosis.

A micro three-dimensional pixel as a constitutional unit of a volume (three-dimensional area of object) is called voxel and proper data representing the characteristic of the voxel is called voxel value. The whole object is represented by three-dimensional array data of the voxel values, which is called volume data. The volume data used for volume rendering is provided by accumulating two-dimensional tomographic image data that is obtained sequentially along the direction perpendicular to the tomographic plane of the object. Particularly for a CT image, the voxel value represents the absorption degree of radiation ray at the position in the object, and is called CT value.

Ray casting is known as a representative calculation method of volume rendering. The ray casting is a method of applying a virtual ray to an object from the projection plane, and creating a three-dimensional image according to virtual reflected light from the inside of the object based on a values (opacity), color information values (color), etc., corresponding to the voxel values, thereby forming a fluoroscopic image of the three-dimensional structure of the inside of the object on the projection plane.

For volume rendering, a method of creating an image based on maximum intensity projection (MIP) method for acquiring the maximum value of the voxel value on a virtual ray, minimum intensity projection (MinIP) method based on the minimum value, average intensity projection method based on the average value, additional value intensity projection method based on the additional value, or the like is available. Multi planar reconstruction (MPR) method for creating an arbitrary sectional image from volume data is also available.

In volume rendering processing, a mask is prepared and a partial region of volume data is selected for drawing. FIGS. 13A and 13B show examples of displaying a heart by volume rendering ray casting for one case of visualizing the internal tissue of a human body. FIG. 13A shows an image provided by drawing volume data including a heart 111. FIG. 13B shows an image provided by drawing only the region of the heart 111 using a mask to exclude the surrounding ribs 112.

FIGS. 14A to 14C are explanatory diagrams of a masking process for rendering the region of the target organ. FIG. 14A shows original data of the region including a target organ 121. Thus, in the image on which the masking process is not performed, the organs surrounding the target organ 121 are displayed on the screen and observation of the target organ 121 maybe hindered in three-dimensional display.

Then, if a binary mask is prepared and mask values of the portions included in a target region 122 as shown in FIG. 14B are set to 1, and mask values of the other portions are set to 0, and if only the portions of which mask values are 1 are drawn as shown in FIG. 14C, only the target organ 121 can be rendered. Although the FIG. 14 is displayed two-dimensionally, target is processed as three-dimensional data in volume rendering, and therefore the mask as shown in FIG. 14B also is a three-dimensional volume data in volume rendering.

Thus, according to the volume rendering, a fluoroscopic image of the three-dimensional structure of only the target organ can be generated from the mask data and the two-dimensional tomographic image data obtained sequentially along the direction perpendicular to the tomographic plane of the target organ.

Anti-aliasing in surface rendering and anti-aliasing in volume rendering based on contrivance of rendering technique are known as related arts (for example, refer to “Anti-Aliased Volume Extraction”, G. -P. Bonneau, S. Hahmann, C. D. Hansen (Editors), Joint EUROGRAPHICS—IEEE TCVG Symposium on Visualization, 2003).

Although the image of only the target region can be provided by the region extraction using binary masking process in the related art described above, when the image is scaled up and each voxel is displayed larger, jaggies in the contour portion of the target region become conspicuous as whether each voxel is included in the region or not is determined by the binary values.

FIG. 15 shows jaggies of the contour when a two-dimensional image is scaled up. As shown in FIG. 15, when a two-dimensional image is scaled up, jaggies occur on a region boundary surface 132 of a target region 131.

FIGS. 16A and 16B show jaggies when a three-dimensional image is scaled up. FIG. 16A shows jaggies of a three-dimensional image obtained by MIP method. FIG. 16B shows jaggies of a three-dimensional image obtained by ray casting method.

Thus, if a three-dimensional volume rendering image is scaled up, voxels in the region boundary become conspicuous and effect of jaggies appears three-dimensionally. Therefore, it may be inconvenient for observing a micro organ in detail such as a blood vessel.

### SUMMARY OF THE INVENTION

An object of the invention is to provide an image processing method capable of making jaggies in the contour portion of a target region inconspicuous when a volume rendering image is scaled up.

In the first aspect of the invention, an image processing method of visualizing biological information by performing volume rendering comprises providing a multi-value mask having three or more levels of mask values, and performing a mask process on a voxel value of an original image based on the multi-value mask so as to render a target region. According to the invention, the target region is rendered based on a multi-value mask having three or more mask values, whereby the mask value can be set stepwise in the vicinity of the boundary surface of the target region, so that when the volume rendering image is scaled up, jaggies in the contour portion of the target region can be made inconspicuous.

In the first aspect of the invention, the image processing method further comprises acquiring an opacity value and a color information value from the voxel value, calculating a synthesized opacity based on the mask value of the multi-value mask and the acquired opacity value, and rendering the target region based on the synthesized opacity and the acquired color information value.

In the image processing method of the first aspect of the invention, the target region is rendered using a plurality of the multi-value masks in combination. In the image processing method of the first aspect of the invention, the target region is rendered using the multi-value mask and a binary mask having binary mask values in combination.

In the image processing method of the first aspect of the invention, the volume rendering is performed using ray casting. In the image processing method of the first aspect of the invention, a virtual ray is projected by a perspective projection or a parallel projection in the volume rendering. In the image processing method of the first aspect of the invention, the volume rendering is performed using a maximum intensity projection method or a minimum intensity projection method.

In the image processing method of the first aspect of the invention, the multi-value mask is calculated dynamically. In the image processing method of the first aspect of the invention, the multi-value mask is converted dynamically into a binary mask. In the image processing method of the first aspect of the invention, the volume rendering is performed by network distributed processing. In the image processing method of the first aspect of the invention, the volume rendering is performed using a graphic processing unit.

In the second aspect of the invention, a computer readable medium having a program including instructions for permitting a computer to perform image processing, the instructions comprise providing a multi-value mask having three or more levels of mask values, and performing a mask process on a voxel value of an original image based on the multi-value mask so as to render a target region.

In the second aspect of the invention, the instructions further comprise acquiring an opacity value and a color information value from the voxel value, calculating a synthesized opacity based on the mask value of the multi-value mask and the acquired opacity value, and rendering the target region based on the synthesized opacity and the acquired color information value.

### BRIEF DESCRIPTION OF THE DRAWINGS

FIG. 1 is a schematic flowchart showing a calculation method of voxel value in related art.

FIGS. 2A1, 2A2, 2A3, 2B1, 2B2 and 2B3 are explanatory diagrams showing an image processing method using a binary mask in related art and an image processing method using a multi-value mask in a first embodiment of the invention.

FIG. 3 is a flowchart showing intuitive calculation method in which mask opacity α2 is considered, of which result does not make sense.

FIG. 4 is an explanatory diagram of the process of intuitive calculation method in which mask opacity α2 is considered, of which result does not make sense.

FIG. 5 is a drawing to describe a difference between the image processing method of a first embodiment of the invention and the related art.

FIG. 6 shows a flowchart of voxel value calculation method in the image processing method of a first embodiment of the invention.

FIG. 7 is an explanatory diagram of the process of the calculation method in the image processing method according to a first embodiment of the invention.

FIGS. 8A and 8B are explanatory diagrams showing dynamic generation of a multi-value mask in an image processing method according to a second embodiment of the invention.

FIG. 9 is an explanatory diagram of a process of generating a multi-value mask dynamically by performing interpolation according to the second embodiment of the invention.

FIG. 10 is a flowchart to describe a calculation method in the image processing method according to the third embodiment of the invention.

FIGS. 11A, 11B and 11C are explanatory diagrams describing the case when binarization is performed after generating a multi-value mask dynamically.

FIG. 12 is a flowchart showing a calculation method applied to a gradient value in the fourth embodiment of the invention;

FIGS. 13A and 13B show examples of displaying a heart by ray casting volume rendering for one case of visualizing the internal tissue of a human body.

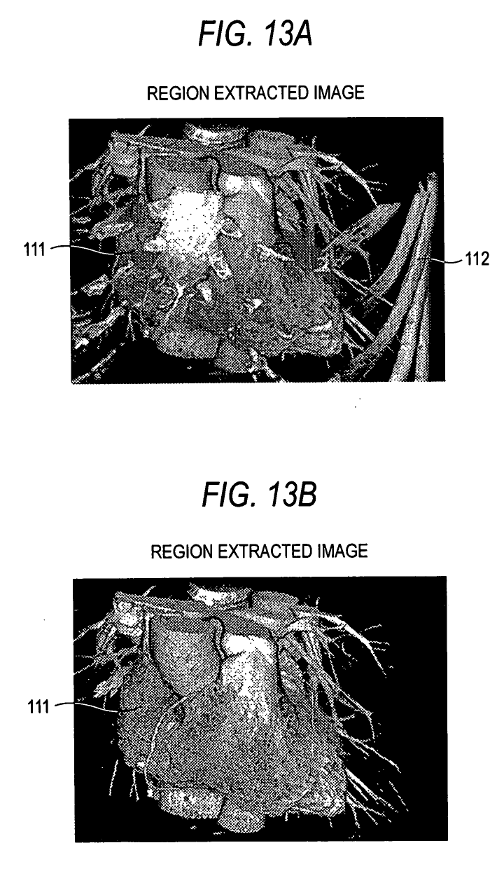

FIGS. 14A, 14B and 14C are explanatory diagrams of a masking process for rendering the region of the target organ.

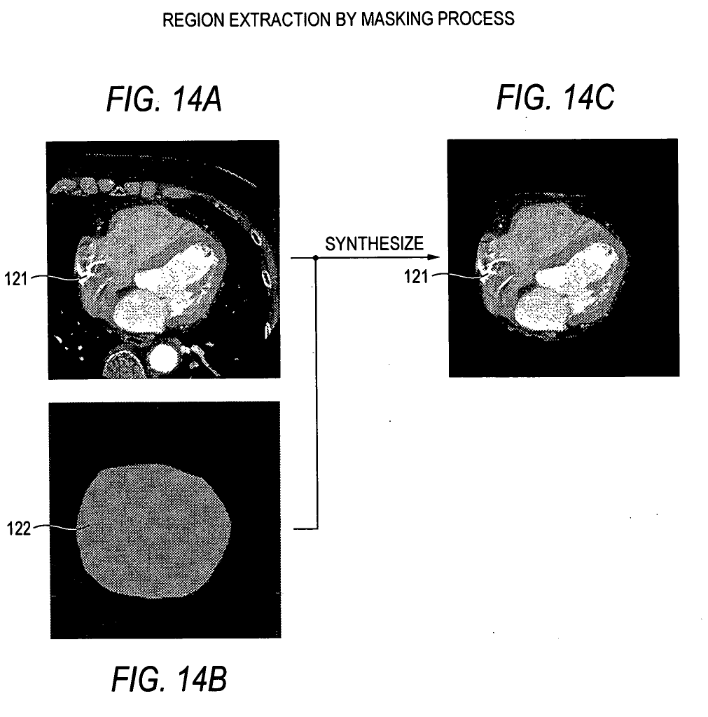

FIG. 15 is an explanatory diagram showing jaggies of the contour when a two-dimensional image is scaled up.

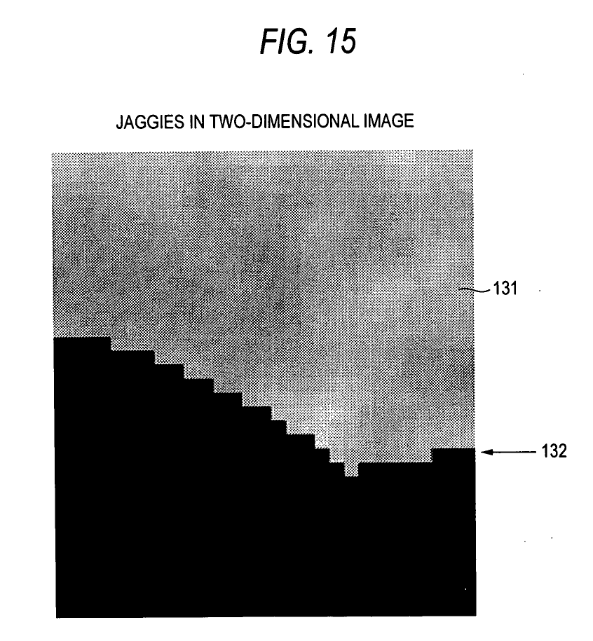

FIGS. 16A and 16B are explanatory diagrams showing jaggies when a three-dimensional image is scaled up.

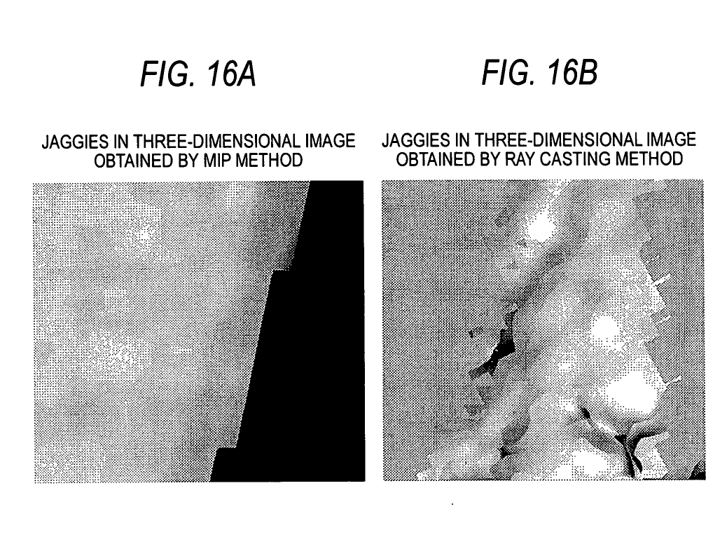

### DESCRIPTION OF THE PRFERED EMBODIMENTS

### First Embodiment

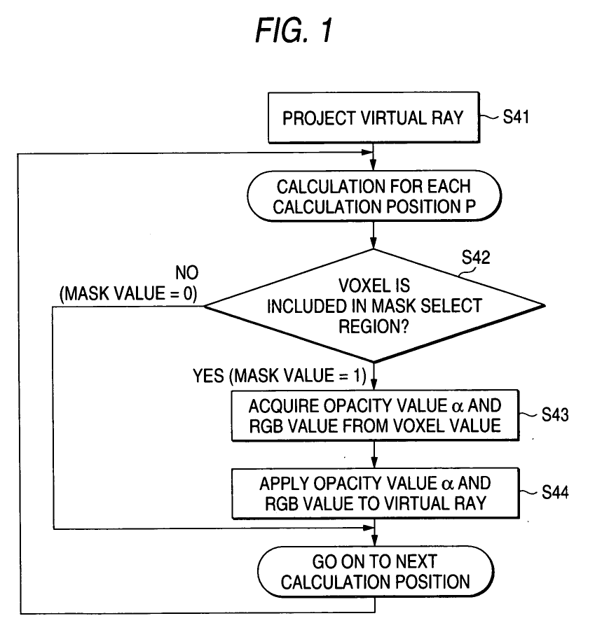

A detailed calculation method using a binary mask in the related art will be discussed before the description of the best mode. FIG. 1 is a schematic flowchart showing a calculation method of voxel value using a binary mask in related art. In the voxel value calculation method using a binary mask in the related art, a virtual ray is projected (step S41), and whether the mask value corresponding to each voxel is 1 or not is determined (step S42). If the mask value is 1 (YES), the voxel is included in the masked region and therefore opacity value α and RGB value (color information value) are acquired from the voxel value (step S43). Then the opacity value α and the RGB value are applied to the virtual ray and the process goes on to the next calculation position. If the mask value is 0 (NO at step S42), the voxel is not included in the mask select region, and therefore calculation of the voxel is not performed and the process goes on to the next calculation position.

However, in the voxel value calculation method in the related art shown in FIG. 1, the mask value is either 0 (transparent) or 1 (opaque) and thus jaggies in the contour portion of the target region are conspicuous.

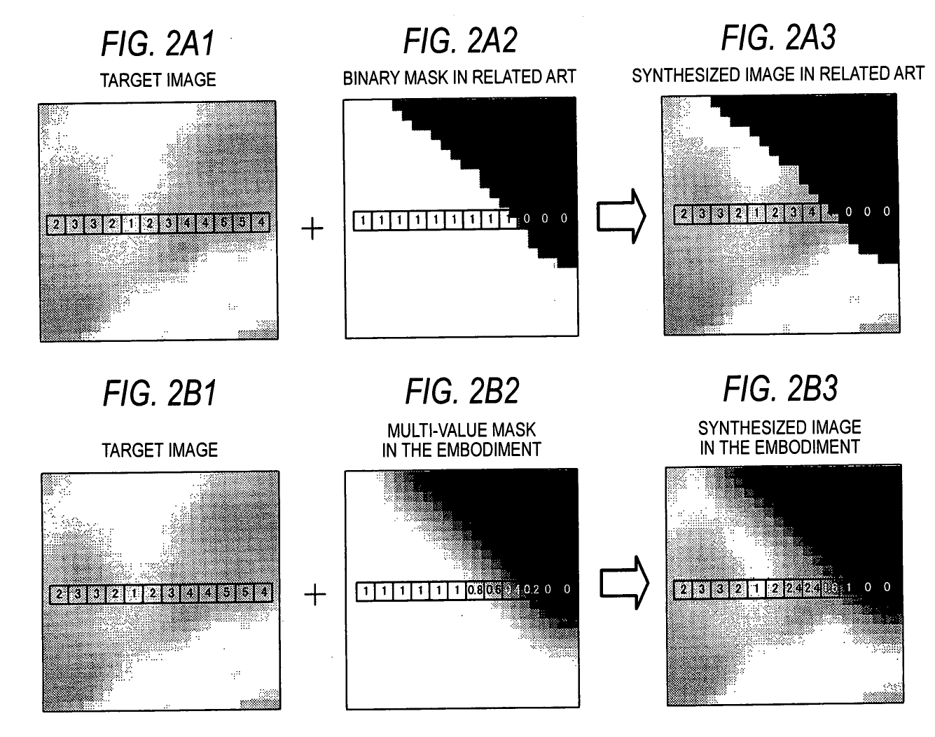

FIGS. 2B1 to 2B3 are explanatory diagrams showing a representation of a multi-value mask in the embodiment. The difference between a binary mask in the related art and a multi-value mask in the embodiment when the target region is rendered by applying the mask to the target image will be described with reference to FIGS. 2A1 to 2A3 and FIGS. 2B1 to 2B3. FIG. 2A1 and FIG. 2B1 show target images in which a target region is scaled up, and are identical images showing the case where the voxel values of one line are “2, 3, 3, 2, 1, 2, 3, 4, 4, 5, 5, 4.”

In an image processing method of the embodiment, a multi-value mask, for example, as shown in FIG. 2B2 is applied on the target image. Each mask value of a binary mask in the related art is either “0” or “1” (“1, 1, 1, 1, 1, 1, 1, 1, 1, 0, 0, 0”) as shown in FIG. 2A2, while each mask value of a multi-value mask in the embodiment is a real value ranging from 0 to 1 corresponding to each voxel (“1, 1, 1, 1, 1, 1, 0.8, 0.6, 0.4, 0.2, 0, 0”) as shown in FIG. 2B2, and in particular has a real value in the boundary area of the target image.

Thus, the synthesized voxel values of a synthesized image provided by applying the mask in the related art to the target image in the related art are “2, 3, 3, 2, 1, 2, 3, 4, 4, 0, 0, 0” as shown in FIG. 2A3 and jaggies are conspicuous on the contours of the target region.

Here, one new idea is that if calculation is performed with the mask value as α value in
pixel value=(1−α)*background RGB value+α*foreground RGB value [Equation 1]
after the model of alpha blend processing in two-dimensional image, synthesized voxel values of the synthesized image become “2, 3, 3, 2, 1, 2, 2.4, 2.4, 1.6, 1, 0, 0” as shown in FIG. 2B3, and it is considered that jaggies of the contours of the target region can be made inconspicuous.

However, if this conception is implemented intuitively direct, problem occurs. As a proper meaning according to the medical image apparatus is assigned to each voxel value, altering the voxel values leads to ignoring the meanings of the voxel values.

For example, in a CT apparatus, voxel value represents a CT value and information is assigned as CT value −1000 is air, CT value 0 is water, and CT value 1000 is bone. Thus, if air (−1000) as foreground, bone (1000) as background, and opacity α=0.5 (translucent) are applied to equation 1, the voxel value becomes
voxel value=(1−0.5)×1000+0.5×(−1000)=0 [Equation 2]
and the boundary between “air” and “bone” is assumed to be “water,” resulting in inappropriate processing. Therefore, multi-value mask used two-dimensionally in the related art cannot be diverted to three-dimensional voxel data without modification.

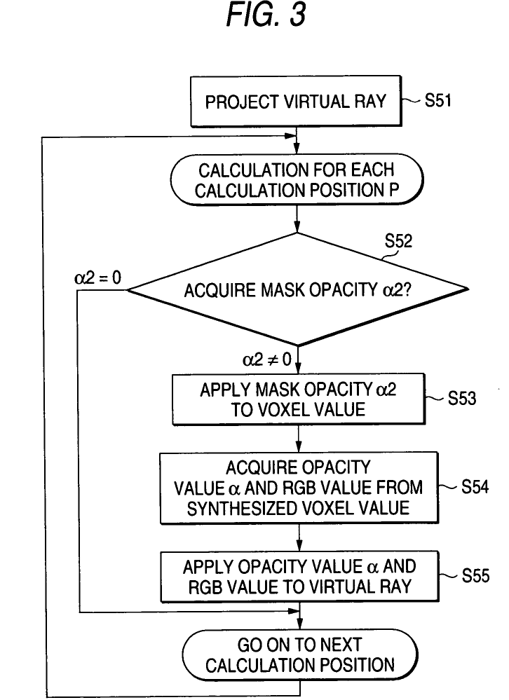

For further explanation, FIG. 3 is a flowchart showing a calculation method whereby the appropriate result cannot be provided although mask opacity α2 is considered. In the calculation method, to calculate the voxel value, a virtual ray is projected (step S51) and mask opacity α2 is acquired (step S52). If mask opacity α2=0 (transparent), the process goes on to the next calculation position. On the other hand, if mask opacity α2≠0 (not transparent), the mask opacity α2 is applied to the voxel value (step S53). Then, opacity value α and RGB value are acquired from the synthesized voxel value provided by applying the mask opacity α2 to the voxel value (step S54), and opacity value α and RGB value are applied to the virtual ray (step S55). Then, the process goes on to the next calculation position.

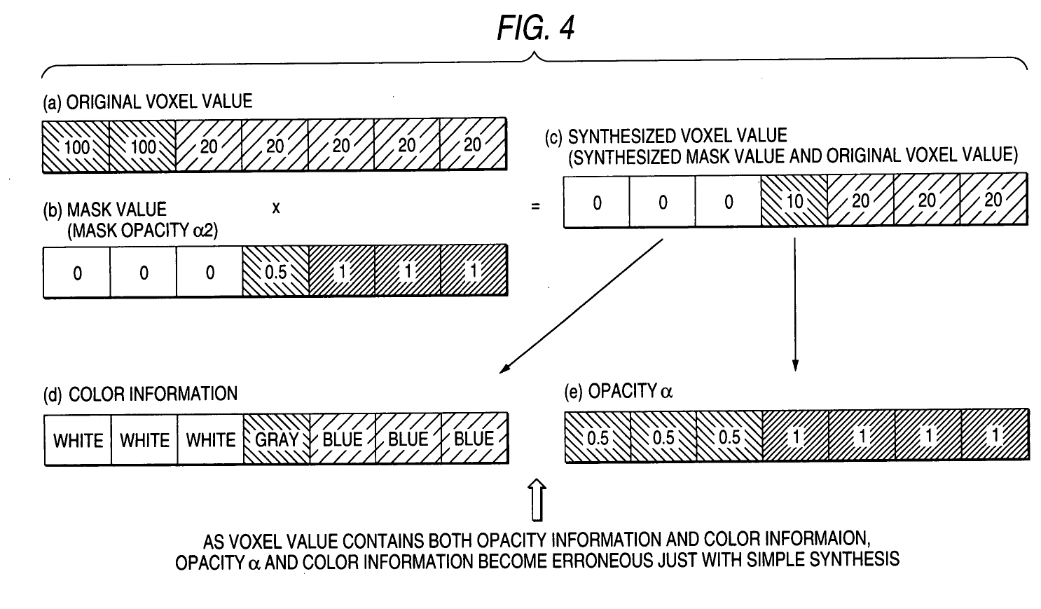

FIG. 4 is an explanatory diagram of the process of the calculation method shown in FIG. 3. In the calculation method, mask value (mask opacity α2) is applied to original voxel value to synthesize the mask value and the original voxel value, providing the synthesized voxel value. In the calculation method, however, the voxel value contains both opacity information and color information, and thus if the mask value and the voxel value are simply synthesized as described above, opacity value α and the color information become erroneous and the appropriate voxel value cannot be obtained. Particularly, as opacity value α is obtained from the synthesized voxel value, inconceivable result is obtained.

To overcome such difficulty, in the invention, when volume rendering processing is performed using a multi-value mask, the opacity value α obtained from the voxel value and the mask opacity α2 are applied to each other without calculating the synthesized voxel value, and no change is added to the color information value obtained from the voxel value.

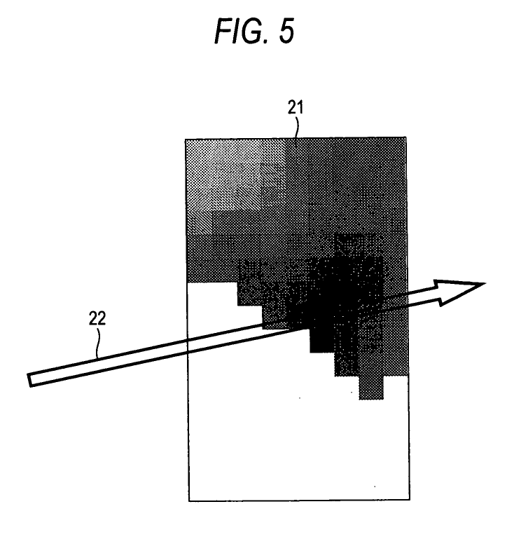

FIG. 5 is a drawing to describe a difference between the image processing method of the embodiment and the inappropriate image processing method described above. In the volume rendering, a virtual ray 22 is applied to a volume 21 and a three-dimensional image is generated according to virtual reflected light from the inside of the object based on a value (opacity value), RGB value (color information value), etc., that correspond to each voxel value of the volume 21. Thus, to implement multi-value mask three-dimensionally, (1) appropriate processing in the translucent portion of the boundary, (2) handling of increase in the memory usage amount, and (3) gradient correction, etc., are necessary.

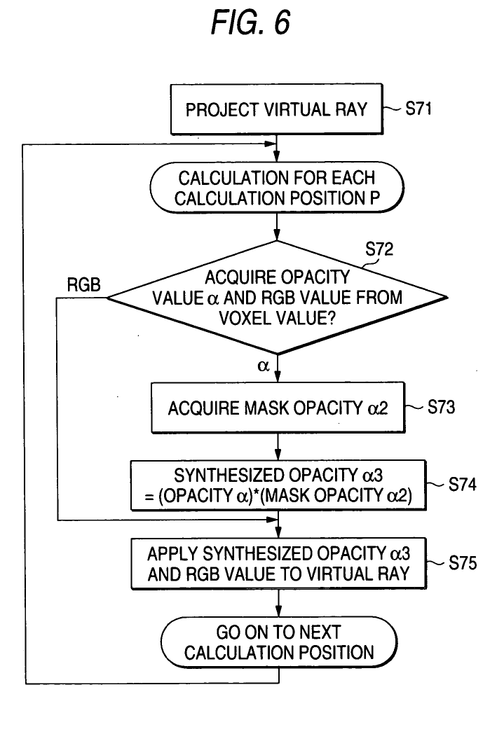

FIG. 6 shows a voxel value calculation method in the image processing method of the embodiment. In the calculation method, to calculate each voxel value, virtual ray is projected (step S71), opacity value α and RGB value (color information value) are acquired from the voxel value (step S72), and mask opacity α2 corresponding to the voxel value is acquired (step S73).

Then,
synthesized opacity α3=opacity α*mask opacity α2 [Equation 3]
is calculated (step S74). At this step, if mask opacity α2=0 which means completely transparent, the synthesized opacity α3 is equal to 0 and therefore branch becomes unnecessary. Next, the synthesized opacity α3 calculated at step S74 and the RGB value provided at step S72 are applied to the virtual ray (step S75), and the process goes on to the next calculation position.

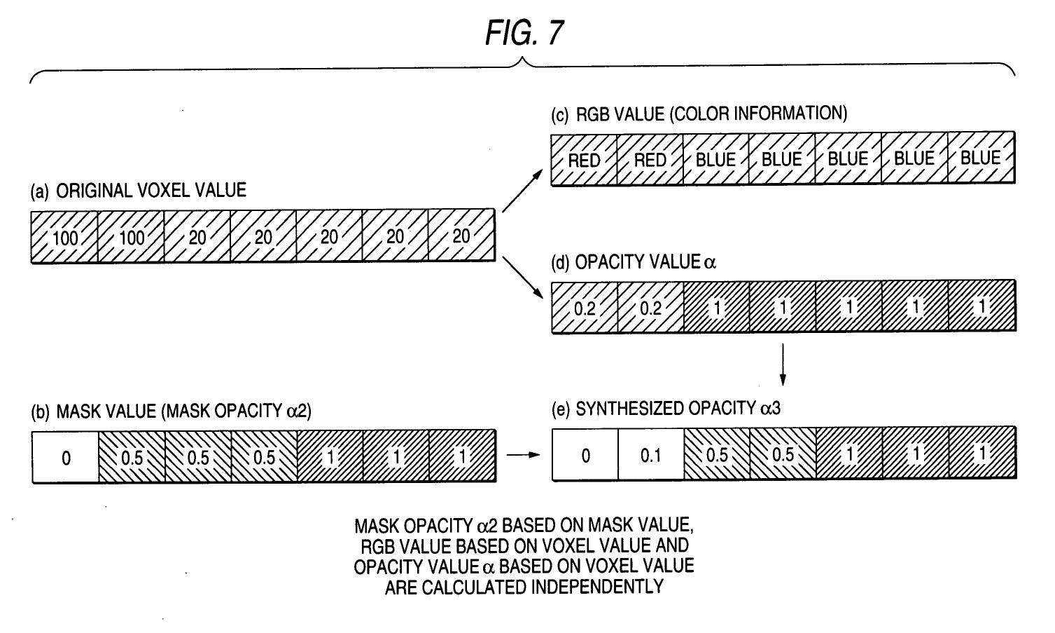

FIG. 7 is an explanatory diagram of the process of the calculation method shown in FIG. 6. In the calculation method, mask opacity α2 based on mask value, RGB value based on voxel value, and opacity value α based on voxel value are calculated independently for each original voxel value, so that the appropriate voxel value can be obtained.

Therefore, according to the image processing method of the embodiment, the target region is rendered based on a multi-value mask having three or more mask values, whereby the mask value can be set stepwise or stepless in the vicinity of the boundary surface of the target region, so that if the volume rendering image is scaled up, jaggies in the contour portion of the target region can be made inconspicuous.

### Second Embodiment

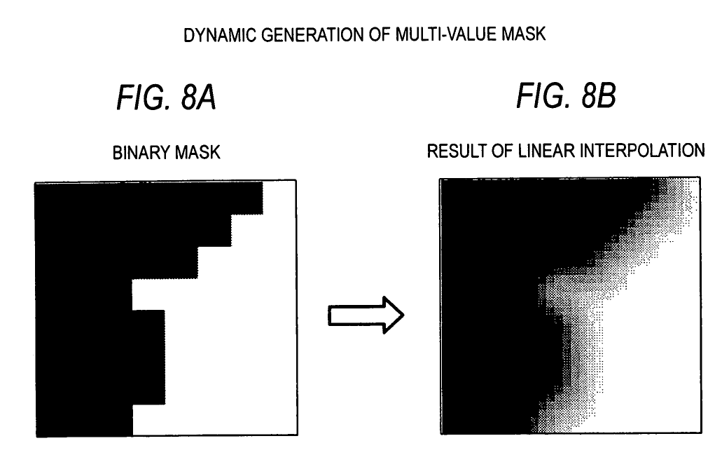

FIGS. 8A and 8B are explanatory diagrams showing dynamic generation of a multi-value mask in an image processing method according to a second embodiment of the invention. In the embodiment, a binary mask is stored without preparing a multi-value mask and, for example, when an image is scaled up, interpolation process is performed for generating a multi-value mask dynamically.

When a virtual ray is projected, for example linear interpolation calculation is performed only in voxels through which the virtual ray passed, based on the binary mask shown in FIG. 8A, and a multi-value mask as shown in FIG. 8B is generated dynamically. For example, when an image is scaled up, interpolation processing is performed so as to generate a multi-value mask dynamically using a binary mask, so that jaggies when an image is scaled up can be made inconspicuous and the memory usage amount to store a multi-value mask can be reduced.

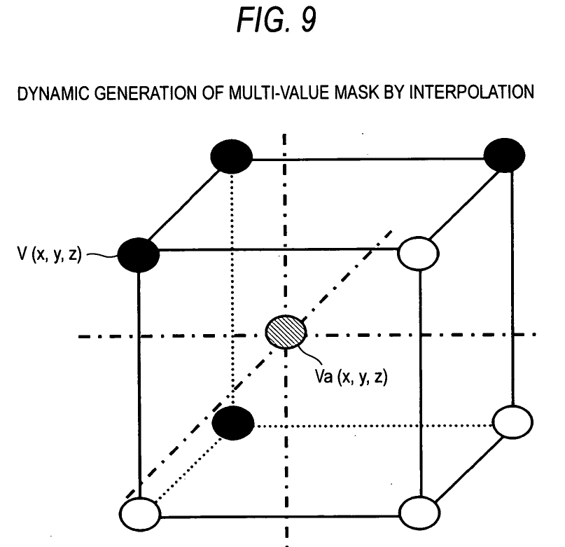

FIG. 9 is an explanatory diagram of a process of generating a multi-value mask dynamically by performing interpolation. Hitherto, as for mask opacity α2 at the position where mask opacity (α2 is not defined, nearby binary information has been used without modification. However in the embodiment, mask opacity α2 at an arbitrary position Va (x, y, z) is obtained from mask information defined only at the integer position of volume V (x, y, z).

A binary-defined mask at voxel point V (x, y, z) is saved and multi-value mask value is obtained by performing interpolation in an intermediate region Va (x, y, z) where no mask is defined. In this case, for the interpolation, a known interpolation method such as linear interpolation or spline interpolation may be used.

### Third Embodiment

The above-described embodiments are embodiments for ray casting; the invention can also be applied to MIP (maximum intensity projection) method. However, in the MIP method, the process of calculating opacity value α from the voxel value does not exist and therefore details of processing differ.

Since the maximum value on a virtual ray is displayed on a screen in the MIP method, a color information value is calculated from the MIP value, and the color information value and the mask value are applied to virtual ray to provide an image. As MIP method is a method that singles a single voxel value on virtual ray, A MIP candidate value is introduced to select the single voxel value. MIP candidate value is acquired by obtaining maximum value of the multiplication value of voxel value of each voxel and the corresponding mask value, whereby the voxel having the larger mask value can take precedence over other voxels. The embodiment is an embodiment into which the conception described above is also introduced.

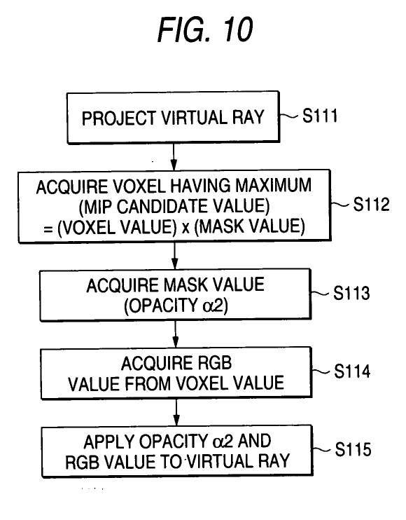

FIG. 10 is a flowchart to describe a voxel value calculation method in the image processing method of the embodiment (maximum intensity projection (MIP) method). In the calculation method, a virtual ray is projected (step S111), and the voxel having the maximum MIP candidate value (voxel value×mask value) is acquired (step S112). Then, mask value (opacity α2) is acquired (step S113), RGB value is acquired from the voxel value (step S114), and the mask opacity α2 and the RBG value are applied to virtual ray (step S115).

Alternatively, the maximum value of the voxels having a mask value equal to or greater than a certain value may be acquired. The maximum value of mask values may be acquired and then the maximum value of voxels may be selected from the maximum value of mask values. In any cases, color information value and the opacity value calculated from the determined maximum value may be applied to virtual ray. When the opacity value is applied, color information value calculated from other voxel or the background color value can also be used.

### Fourth Embodiment

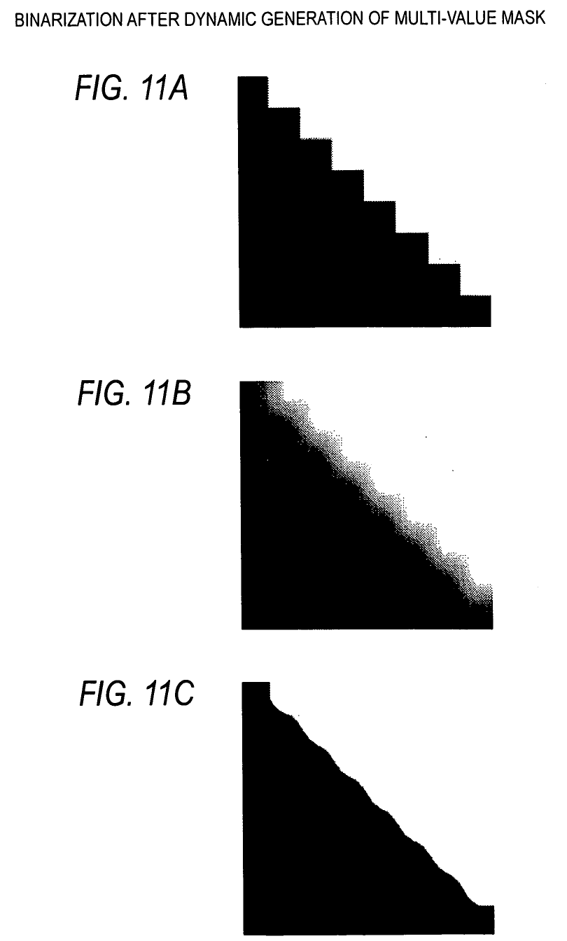

In the second embodiment, the interpolation values of a binary mask assigned to voxels are obtained dynamically as a multi-value mask; the multi-value mask may be binarized again. FIGS. 11A to 11C describe that the mask boundary surface is smoothly displayed by the process of binarization after generating a multi-value mask dynamically. FIG. 11A shows a state in which a binary mask assigned to voxels is scaled up. When a binary mask assigned to voxels is scaled up using interpolation, the result is as shown in FIG. 11B. When the result is binarized again, relatively smooth mask boundary surface can be provided as shown in FIG. 11C. It is efficient because calculation is not required to be performed in advance but calculation is performed only when the calculation is necessary.

It is further effective when the direction of the boundary surface can be represented in an image in addition to the above-described process. For this purpose, in fourth embodiment of the invention, gradient is used for representing reflected light.

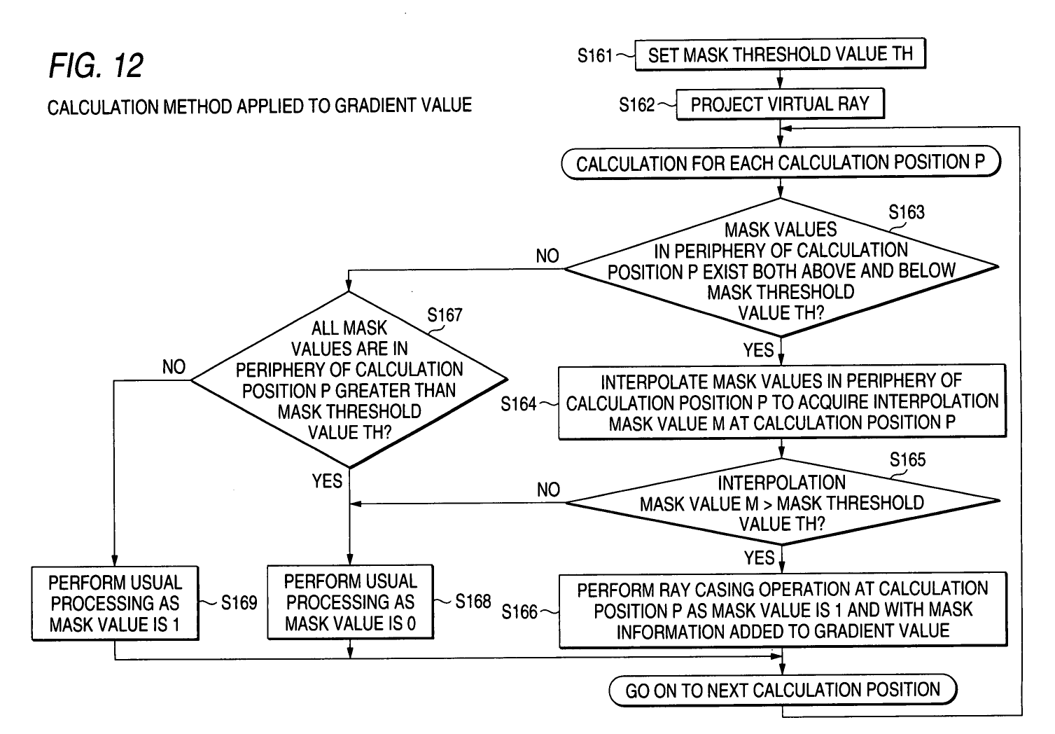

FIG. 12 is an explanatory diagram in the case of using a multi-value mask for calculation of opacity and reflected light in an image processing method according to the fourth embodiment of the invention. In the method of the embodiment, a multi-value mask is applied to the reflected light, whereby a smoother curved surface can be drawn in the mask boundary portion. The embodiment is particularly effective when the embodiment is combined with dynamic generation of a multi-value mask in the third embodiment. Gradient value is used for representing reflected light.

FIG. 12 is a flowchart to describe a voxel value calculation method in an image processing method of the fourth embodiment. In the calculation method, a mask threshold value TH to binarize a mask is set (step S161), a virtual ray is projected (step S162), and calculation is performed for each point used in the calculation on virtual ray. To perform calculation for each point, whether or not mask values in the periphery of the calculation position P exist both above and below the mask threshold value TH is determined (step S163). If mask values exist only above or only below the mask threshold value TH, the mask is binarized (steps S167, S168, S169).

If mask values in the periphery of the calculation position P exist both above and below the mask threshold value TH, the mask values on the periphery of the calculation position P are interpolated to acquire an interpolation mask value M at the position P (step S164), and whether or not the interpolation mask value M is greater than the mask threshold value TH is determined (step S165).

If the condition is not satisfied, binarization is executed, and opacity is 0, and therefore processing is performed as mask value is 0 (step S168). If the condition is satisfied, binarization is executed, and opacity is 1, and therefore processing is performed as mask value is 1 and further in addition to usual processing, calculation with mask information added to the gradient value is performed (step S166).

A method of adding the mask information to the gradient value is illustrated. In ray casting processing wherein no mask information is added, gradient value can be obtained by six nearby voxel values relative to XYZ axis directions of calculation position P by interpolation, and calculating their difference (For example, refer to JP-A-2002-312809). In order to acquire the gradient value to which the mask information is added, the six nearby voxel values are multiplied by the mask values corresponding to each position, and then the difference may be calculated.

To acquire the gradient value to which the mask information is added, the difference of the six nearby mask values can also be calculated. In this case, the calculation is speeded up although the image quality is degraded.

The mask value maybe a multi-value mask value calculated by interpolation, or may be a mask value provided by further binarization of the multi-value mask value.

Processing of averaging the gradient value to which the mask information is added and the gradient value to which the mask information is not added, or the like may also be performed.

In surface rendering, there is a method such as eliminating jaggies by anti-aliasing process which degrades the resolution after the calculation at a higher resolution than that of the final image. However, when similar processing is performed in volume rendering, jaggies are not eliminated. If calculation is performed with the resolution raised, the target mask voxel is also scaled up for calculation, and consequently the voxel of the size matched with the resolution is only drawn. This is equivalent to the fact that if calculation is performed with the resolution raised in surface rendering, the number of polygons does not change and therefore sufficient image quality improvement cannot be expected. Surface rendering is a method wherein surface data is formed with elements forming surfaces of a polygon, etc., as units and a three-dimensional object is visualized.

A part or all of the image processing of the embodiment can be performed by a GPU (graphic processing unit). The GPU is a processing unit designed to be specialized particularly in image processing compared to a general-purpose CPU, and is usually installed in a computer separately from a general-purpose CPU.

In the image processing method of the embodiment, volume rendering calculation can be divided by a predetermined image region, volume region, etc., and later the divided calculation can be combined, so that the method can be executed by parallel processing, network distributed processing or a dedicated processor, or using them in combination.

The image processing of the embodiment can also be used in virtual ray projection method for image projection method. For example, parallel projection, perspective projection, and cylindrical projection can be used.

The image processing of the third embodiment is an example about the maximum intensity projection (MIP) method; it can also be used with minimum intensity projection method, average intensity projection method, and ray-sum projection method.

The image processing of the embodiment is image processing using a multi-value mask, but for example, the multi-value mask can be converted to a binary mask by binarization using a threshold value. Accordingly, for example, the multi-value mask is used only when a volume is scaled up and rendered; otherwise, the binarized mask is used, whereby the calculation amount can be decreased.

The image processing of the embodiment uses RGB values as color information values, but any type of values such as CMY values, HSV values, HLS values, or monochrome gradation values can be used if colors can be represented.

In the embodiment, the number of mask is one, but a plurality of multi-value masks can be used. In this case, mask opacity can be the multiplication of each mask values, or the maximum value or the minimum value of the mask values, and various combinations can be considered.

In the embodiment, the number of mask is one, but a multi-value mask and a binary mask can be used in combination. In this case, image processing is performed in such a manner that the calculation method is applied only to the voxel whose binary mask value is opaque, or that mask opacity is assigned to binary mask value and a plurality of multi-value masks are assumed to exist.

In the second embodiment and fourth embodiment, binary mask is interpolated for generating a multi-value mask, but the multi-value mask maybe further interpolated for generating a multi-value mask.

According to the invention, the target region is rendered based on a multi-value mask having three or more mask values, whereby the mask value can be set stepwise in the vicinity of the boundary surface of the target region, so that if the volume rendering image is scaled up, jaggies in the contour portion of the target region can be made inconspicuous.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. An image processing method of visualizing biological information by performing volume rendering, said image processing method comprising:
providing a multi-value mask having three or more levels of mask values; and
performing a mask process on a voxel value of an original image based on said multi-value mask so as to render a target region.

2. The image processing method as claimed in claim 1, further comprising:
acquiring an opacity value and a color information value from the voxel value;
calculating a synthesized opacity based on the mask value of the multi-value mask and the acquired opacity value; and
rendering the target region based on said synthesized opacity and the acquired color information value.

3. The image processing method as claimed in claim 1 wherein the target region is rendered using a plurality of said multi-value masks in combination.

4. The image processing method as claimed in claim 1 wherein the target region is rendered using said multi-value mask and a binary mask having binary mask values in combination.

5. The image processing method as claimed in claim 1 wherein said volume rendering is performed using ray casting.

6. The image processing method as claimed in claim 1 wherein a virtual ray is projected by a perspective projection or a parallel projection in the volume rendering.

7. The image processing method as claimed in claim 1 wherein the volume rendering is performed using a maximum intensity projection method or a minimum intensity projection method.

8. The image processing method as claimed in claim 1 wherein said multi-value mask is calculated dynamically.

9. The image processing method as claimed in claim 1 wherein said multi-value mask is converted dynamically into a binary mask.

10. The image processing method as claimed in claim 1 wherein said volume rendering is performed by network distributed processing.

11. The image processing method as claimed in claim 1 wherein said volume rendering is performed using a graphic processing unit.

12. A computer readable medium having a program including instructions for permitting a computer to perform image processing, said instructions comprising:
providing a multi-value mask having three or more levels of mask values; and
performing a mask process on a voxel value of an original image based on said multi-value mask so as to render a target region.

13. The computer readable medium as claimed in claim 12, said instructions further comprising:
acquiring an opacity value and a color information value from the voxel value;
calculating a synthesized opacity based on the mask value of the multi-value mask and the acquired opacity value; and rendering the target region based on said synthesized opacity and the acquired color information value.

14. The computer readable medium as claimed in claim 12 wherein said multi-value mask is converted dynamically into a binary mask.
